(19) United States
(12) Patent Application Publication
(10) Pub. No.: US 2016/0314024 A1
(43) Pub. Date: Oct. 27, 2016

(54) CLEARANCE MODE IN A MULTICORE PROCESSOR SYSTEM

(71) Applicant: MediaTek Inc., Hsinchu (TW)

(72) Inventors: Ya-Ting Chang, Hsinchu (TW); Ming-Ju Wu, Hsinchu (TW); Pi-Cheng Chen, Kaohsiung (TW); Jia-Ming Chen, Zhubei (TW); Chung-Ho Chang, Zhubei (TW); Pi-Cheng Hsiao, Taichung (TW); Hung-Lin Chou, Zhubei (TW); Shih-Yen Chiu, Hsinchu (TW)

(21) Appl. No.: 15/098,876

(22) Filed: Apr. 14, 2016

Related U.S. Application Data
(60) Provisional application No. 62/152,224, filed on Apr. 24, 2015.

(51) Int. Cl. G06F 9/50

(52) U.S. Cl. CPC G06F 9/5088; G06F 9/505

(57) ABSTRACT

A computing system supports a clearance mode for its processor cores. The computing system can transition a target processor core from an active mode into a clearance mode according to a system policy. The system policy determines the number of processor cores to be in the active mode. The transitioning into the clearance mode includes the operations of migrating work from the target processor core to one or more other processor cores in the active mode in the computing system; and removing the target processor core from a scheduling configuration of the computing system to prevent task assignment to the target processor core. When the target processor core is in the clearance mode, the target processor core is maintained in an online idle state in which the target processor core performs no work.

### CROSS-REFERENCE TO RELATED APPLICATIONS

This application claims the benefit of U.S. Provisional Application No. 62/152,224 filed on Apr. 24, 2015.

### TECHNICAL FIELD

Embodiments of the invention relate to the management of processor cores in a multicore processor system.

### BACKGROUND

Most modern computing systems provide hot-plug support that allows a processor core to be powered on or off, or physically inserted or removed during operating system (OS) runtime. In a multicore processor system that supports hot-plug, the OS can unplug a processor core to remove it from the system, and can replug it back into the system on demand. A hot-pluggable system is adaptable to the changing capacity demand, as processor cores can be dynamically provisioned on demand. Moreover, for system reliability purposes, a hot-pluggable system can remove a faulty processor core during OS runtime, keeping the processor core off the system execution path.

While hot-plug saves power and enhances system reliability, the unplugging and re-plugging processes often require large amounts of time-consuming operations and memory manipulations. When a processor core is unplugged from a system, the processor core is offline and powered off. In a Linux system, the processor core is offline with respect to the OS and all of the OS subsystems, such as the scheduler, networking, memory management, power management, etc. All of its existing tasks are immediately migrated and future event-handling functions are immediately disabled. The entire, or nearly entire, data structures of its logical context are generally freed and its memory space is de-allocated. When the processor core is re-plugged back online, all of its data structures need to be re-initialized and its de-allocated memory re-claimed. Thus, the hot-plugging process is generally slow and power inefficient.

Some systems place a processor core into deep sleep when the processor core runs out of tasks and is predicted not to receive any tasks for a period of time. However, a sleeping processor core typically does not remain in the deep sleep for long as it may be frequently woken up to perform assigned tasks. Frequently transitioning a processor core between operation and deep sleep degrades system performance. Therefore, there is a need to improve the management of processor cores in a multicore processor system.

### SUMMARY

In one embodiment, a method is provided for operating a computing system that includes a plurality of processor cores. The method comprises transitioning a target processor core in the computing system from an active mode into a clearance mode according to a system policy. The system policy determines a number of processor cores to be in the active mode. The transitioning into the clearance mode further comprises: migrating work from the target processor core to one or more other processor cores in the active mode in the computing system; and configuring the computing system to prevent task assignment to the target processor core. While the target processor core is in the clearance mode, the target processor core is maintained in an online idle state in which the target processor core performs no work.

In another embodiment, a system that includes processor cores and memory. The memory contains instructions executable by the processor cores. The computing system is operative to transition a target processor core in the computing system from an active mode into a clearance mode according to a system policy. The system policy determines a number of processor cores to be in the active mode. To transition into the clearance mode, the kernel module is further configured to: migrate work from the target processor core to one or more other processor cores in the active mode in the computing system; and configure the computing system to prevent task assignment to the target processor core. While the target processor core is in the clearance mode, the target processor core is maintained in an online idle state in which the target processor core performs no work.

According to embodiments described herein, a multicore processor system provides a clearance mode for processor cores such that the system can have fast response, efficient power usage, and improved performance.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates a multicore processor system according to one embodiment.

FIG. 2 illustrates an example of system modules according to one embodiment.

FIG. 3 is a flow diagram illustrating a process of a target processor core entering a clearance mode according to one embodiment.

FIG. 4 is a flow diagram illustrating a process of a target processor core exiting a clearance mode according to one embodiment.

FIG. 5 is a flow diagram illustrating a method for operating a multicore processor system according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

It should be noted that the term “multicore processor system” as used herein may be arranged and managed as one or more clusters. A multicore processor system may be a multicore system or a multi-processor system, depending upon the system implementation. In other words, the proposed method may be applicable to any multicore system and multi-processor system arranged and managed as one or more clusters. For example, concerning the multicore system, all of the processor cores may be disposed in one processor. As another example, concerning the multi-processor system, each processor core may be disposed in one processor. Hence, in a multicore processor system, each cluster may be implemented as a group of one or more processors.

Embodiments of the invention provide a system and method for managing operations of processor cores in a multicore processor system. The system operates according to a system policy that determines the number of processor cores required to be in an active mode. According to the system policy, the system transitions a target processor core in the computing system from the active mode into a clearance mode. To transition the target processor core into the clearance mode, the system migrates work from the target processor core to one or more other processor cores in the active mode in the computing system, and configure the computing system to prevent task assignment to the target processor core. While the target processor core is in the clearance mode, the target processor core is maintained in an online idle state in which the target processor core performs no work.

The term “online,” as used herein, describes the perspective of the OS kernel in connection with a processor core. An “online” processor core means that the logical context of the processor core is available, and that the processor core is in an operable state from the OS kernel' view. An online processor is “alive” to the OS kernel, because it can be woken up and return to the active mode to receive task assignments. A processor core is “idle” when it performs no work.

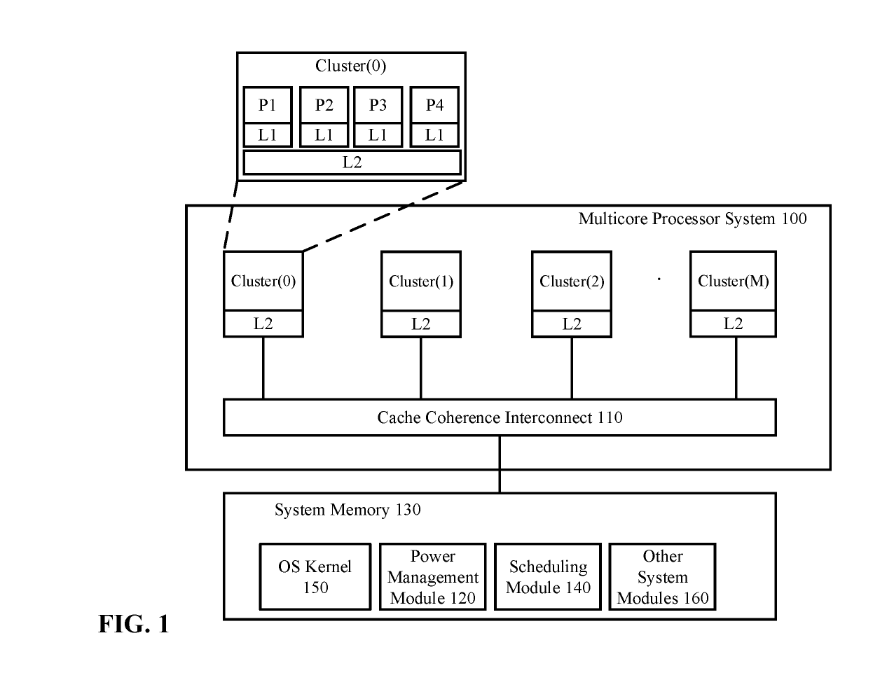

FIG. 1 illustrates an example of a multi-core processor system 100 according to one embodiment. In this example, the multicore processor system 100 includes multiple clusters of processor cores: Cluster(0), Cluster(1), . . . , Cluster(M). In alternative embodiments, the multicore processor system 100 may include any number of clusters that is at least one. Each cluster includes one or more processor cores, which may be identical or different processor types. As used herein, a “processor type” refers to common characteristics shared by a group of processor cores, where the common characteristics include, but are not limited to, energy efficiency characteristics and computation performance. As an example, Cluster(0) is shown on top of FIG. 1 as including four processor cores P1-P4.

In one embodiment, the multicore processor system 100 includes a multi-level cache structure. For example, each processor core may include or has exclusive access to an L1 cache, and processor cores of the same cluster may share the same L2 cache or additional levels of caches. In another embodiment, each processor core may include or has exclusive access to an L1 cache and an L2 cache, and processor cores of the same cluster may share the same L3 cache or additional levels of caches. It is noted that in further other embodiments, each processor core may include or has exclusive access to one or more cache, and processor cores of the same cluster may share the same one or more caches. In addition to the shared cache(s), processor cores of the same cluster may share other hardware components such as a memory interface, timing circuitry, and other shared circuitry. Processor cores in each cluster also have access to a system memory 130 via a cache coherence interconnect 110. The cache coherence interconnect 110 includes coherence circuitry (e.g., snooping circuitry) that keeps track of the status of the cache lines in the caches of each cluster to maintain cache coherence among the clusters.

In one embodiment, the multicore processor system 100 also includes an OS kernel 150 which includes or controls a number of system modules. These system modules may also be referred to as subsystems. In one embodiment, the system modules include a power management module 120, a scheduling module 140 and other system modules 160 such as networking module, memory management module, file system module, etc. The power management module 120 manages the power state of each processor core and each cluster to satisfy system design requirements such as to achieve energy efficiency. For example, the power management module 120 may transition any processor core in any cluster from a power-on state into a power-off or ultra-low power state, and any processor core in any cluster from the power-off or ultra-low power state into the power-on state. In one embodiment of the ultra-low power state, power consumed in the cluster can be as low as to retain data in the caches but not enough to afford logical calculations. The scheduling module 140 assigns and schedules tasks to the processor cores. The embodiment of FIG. 1 shows the OS kernel 150, the power management module 120, the scheduling module 140 and the other system modules 160 as software modules; in alternative embodiments these modules may be implemented by hardware, firmware, or a combination of hardware/firmware and software. In an embodiment where the modules 120, 140, 150 and 160 are implemented by software, the software may be stored in the system memory 130 or other non-transitory computer readable medium accessible by the multicore processor system 100. The software may be executed by a centralized hardware unit or by the active processor cores in the multicore processor system 100.

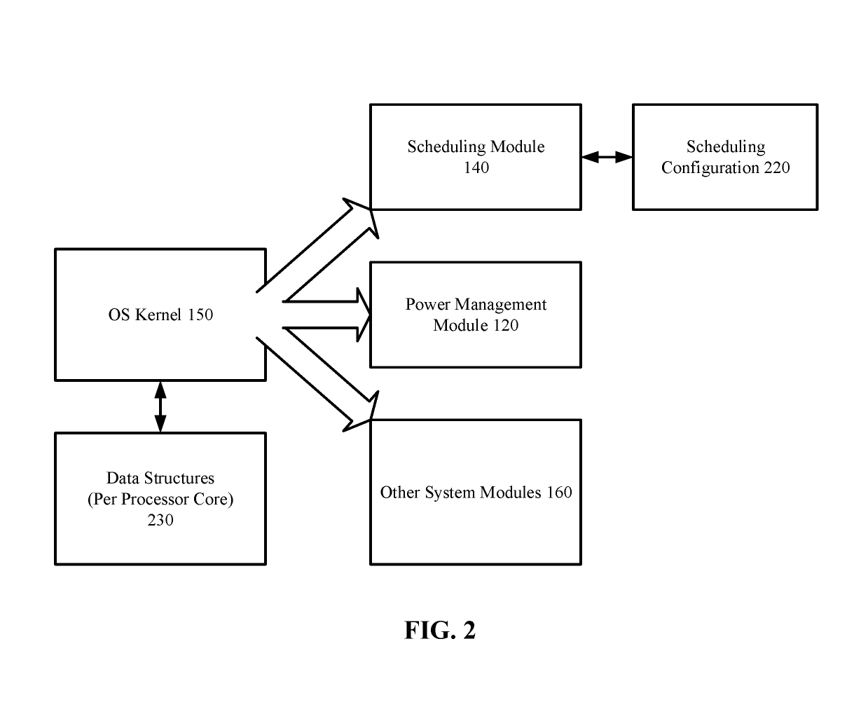

FIG. 2 illustrates further details of the OS kernel 150 that manages the operations of system modules according to another embodiment. The system modules include the power management module 140, the scheduling module 120 and other system modules 160. In this embodiment, the operations of the system modules including the power management module 120 and the scheduling module 140 are controlled by the OS kernel 150. The scheduling module 140 maintains a scheduling configuration 220 that enables “core configuration aware scheduling” (CAS). The scheduling configuration 220 records, among other things, the processor cores that are in the active mode. When a processor core is in the active mode, the scheduling module 140 can schedule work to it and the processor core can perform the scheduled work. By contrast, when a processor core is in the clearance mode, the processor core is removed from the scheduling configuration 220 such that it is not usable to the scheduling module 140. When there are new tasks to be assigned, the scheduling module 140 cannot schedule these new tasks to a processor core in the clearance mode, thus preventing waking up the processor core from the clearance mode. In contrast to conventional sleep or deep sleep modes in which a processor core can be woken up by a scheduler to receive scheduled tasks, the clearance mode allows a processor core to avoid all future work assignments to the processor core. So the future work assignments (e.g., interrupt requests) may bypass the processor core and be diverted to other processor cores in the active mod Similarly, a processor core in the clearance mode may be removed from the configurations of one or more other system modules 160 to prevent these system modules from waking up the processor core to handle work. There may be some exceptional cases implemented. For example, the processor core may still be woken up when there is an explicit command or need for this particular processor core to wake up. In some embodiments, if a user-written module (e.g., a user-written driver) requests to wake up a target processor core in the clearance mode, the system may issue a warning to the user indicating that the target processor core is in the clearance mode. The user may then cancel the request, divert the request to other processor cores, or proceed to wake up the target processor core.

In one embodiment, any processor core and any cluster may enter the clearance mode according to a system policy that determines fewer than all of the processor cores in the system need to be active (e.g., due to reduced workload, power consumption requirement, etc.). The processor cores that enter the clearance mode include those in active operation of tasks, but do not need to be active according to the system policy. That is, a processor core enters the clearance mode not because it runs out of tasks and is predicated not to receive any task for a predetermined time period, but because the system policy dictates the clearance mode entrance and forces the existing and future tasks to be migrated or removed. A processor core in the clearance mode is in an online idle state. The processor core is “online” because it is alive to the OS kernel 150, and can be woken up and return to the active mode to receive task assignments. The processor core is “idle” because it performs no work. As the processor core performs no work, it can be powered-off or enter an ultra-low power state.

In comparison with the conventional sleep or deep sleep modes in which any processor core can be idle when there is no task in the run queue, a target processor core can be transitioned into the clearance mode according to a system-wide processor strategy to forcibly clear all workload in the target processor. Moreover, in the conventional sleep or deep sleep modes, if a processor core enters an idle state and is predicted to be woken up by a future awaking event (e.g., timer) a long time later (e.g., after a predetermined time period), the processor core can then sequentially or gradually transition to the lower power states or enter the powered off state. In contrast, if the target processor core enters an online idle state and is in the clearance mode, it can directly or immediately enter an ultra-low power state or be powered off as required. Furthermore, in the conventional sleep or deep sleep modes, the processor cores can be woken up from the sleep or deep sleep modes due to workload not being cleared from the processor cores. This can prevent the processor cores from remaining in the sleep or deep sleep modes for a longer period of time. In contrast, when the target processor core(s) is in the online idle state, the core configuration aware scheduling (CAS), system software, and applications can be aware that there are processor core(s) in the clearance mode and therefore do not assign tasks to the processor cores(s). The processor core(s) can therefore remain in the clearance mode as long as it is required by the system-wide processor strategy.

Each processor core may be associated with a logical context that contains pointers and data for its operation. For each processor core, the OS kernel 150 maintains a set of data structures 230 of the logical context associated with the processor core in one or more memory devices. In one embodiment, when a processor core enters the clearance mode, the OS kernel 150 maintains the entire data structures of the logical context associated with the processor core in one or more memory devices. In an alternative embodiment, when a processor core enters the clearance mode, the OS kernel 150 maintains at least a first portion of data structures of the logical context associated with the processor core, while freeing a second portion of the data structures of the logical context associated with the processor core. In this alternative embodiment when the processor core wakes up from (i.e., exits) the clearance mode, the OS kernel 150 only allocates and initializes the second portion of the data structures without allocating and initializing the first portion of the data structures. The first portion of the data structures may include the data structure(s) used by the scheduling module 140, and the second portion of the data structures may include the data structure(s) used by one or more other system modules 160. In an alternative embodiment, the second portion of the data structures may include the data structure(s) used by the scheduling module 140, and the first portion of the data structures may include the data structure(s) used by one or more other system modules 160. In further another embodiment, either of the first and second portions can include data structures used by either or both of the scheduling module 140 and one or more other system modules.

Compared to the conventional technologies that make a processor core go offline and remove all of the logical context associated with the offline processor core, the processor core in the clearance mode is kept online, without removing all of the associated logical context. While the disclosed clearance mode typically involve migration only, in some cases the clearance mode may involve both migration and thread parking. Thread parking refers to a facility which retains per process core thread data structure to avoid the full teardown and setup of per processor core threads. Moreover, with the conventional technologies, to restore a dead or offline processor core back to the online state, data structures associated with all modules affected by an online mask of the operating system kernel need to be initialized or re-initialized (including allocating or reclaiming memories), resulting in a heavy task and a lengthy operation time. In contrast, to restore an online processor core in the clearance mode back to the active mode is a lighter operation that can be completed in a shorter amount time.

It is noted that in the above embodiment, removing the target processor core from a scheduling configuration of the computing system is described as one method to prevent task assignment to the target processor core. However, in other embodiments, there can be different ways implemented to configure the computing system such that tasks will not be assigned to the target processor core in the clearance mode. For example, a measure of appropriateness associated with the target processor core can be changed such that in determining which one of the processor cores is more suitable or appropriate to take a task, it can be calculated from the measure that task assignment to the target processor core is less appropriate compared to task assignment to the other processor cores in the active mode. In one embodiment, a respective cost brought by task assignment to the target processor core or other processor cores may be calculated as a measure of appropriateness used for determining which processor core is more appropriate to execute the task. For example, the cost associated with task assignment to the target processor core in the clearance mode can be set to a higher value to such an extent that the target processor core in the clearance mode can avoid task assignments.

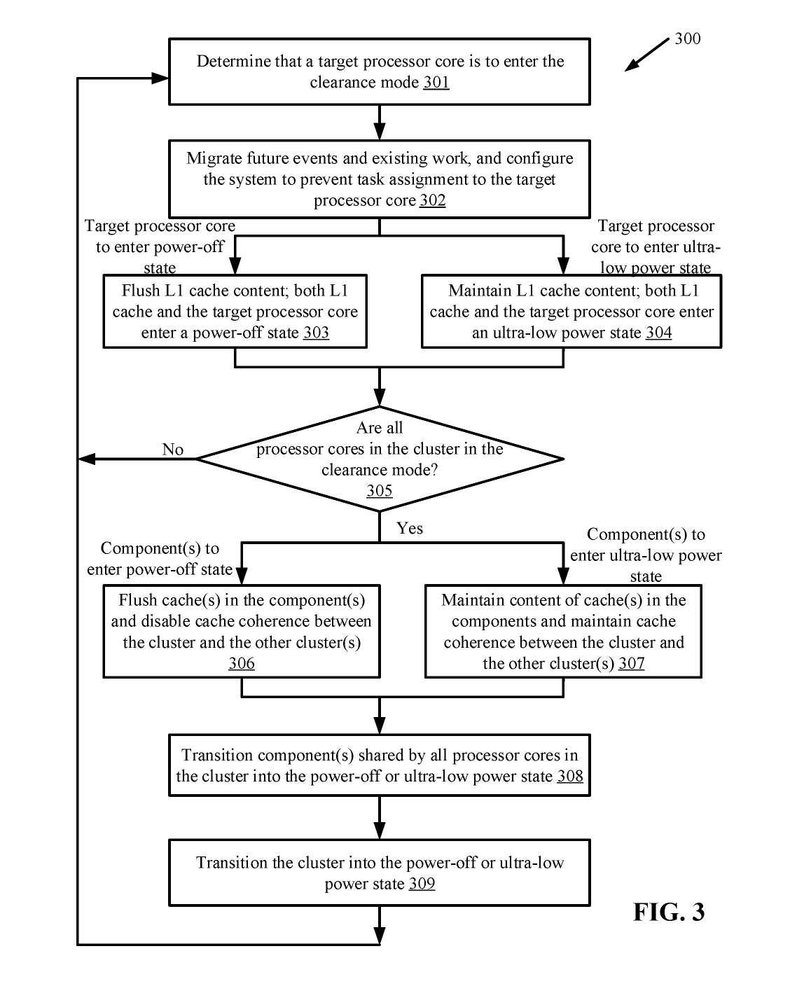

FIG. 3 is a flow diagram illustrating a process 300 of a target processor core entering the clearance mode according to one embodiment. The process 300 may be performed by a system such as the multicore processor system 100 of FIG. 1. In this embodiment, when the system determines at step 301 that a target processor core in the system is to enter the clearance mode according to a system policy, all future events and existing work are migrated from the target processor core to at least one other processor core in the active mode at step 302. More specifically, not only the existing workload is migrated, but also the function of handling future external events is removed from the target processor core to at least one processor core in the active mode. An example of the function of handling future external events is the interrupt-handling function. In one embodiment, the system may include a generic interrupt controller (GIC), which forwards interrupt requests to processor cores in the system. The GIC can be configured not to forward any interrupt requests to the target processor core such that the target processor core will not receive any future interrupt requests. The existing workload that is migrated from the target processor core may include, but is not limited to, already-assigned tasks, already-received interrupted requests, background processes (i.e., per-processor processes), etc. In one embodiment, some of the per-processor processes may be migrated to other active processor cores, and some of the per-processor processes (e.g., the workqueue daemon) may remain on the target processor core but are guaranteed to receive no future workload to prevent waking up the target processor core from the clearance mode.

It is noted that a processor core in the clearance mode may preferably not undergo any operating parameter changes in order to maintain system stability and prevent system errors. The operating parameters may include voltage and frequency, which means that dynamic voltage frequency scaling (DVFS) is preferably not performed on the processor core in the clearance mode. To achieve this end, in one embodiment, modules in the multi-core processor system 100 can avoid adjusting operating parameters of the processor core in the clearance mode. For example, the modules may ignore any adjustment operation or requirement or request on the processor core in the clearance mode. Alternatively or additionally, a pseudo processor core, which exists logically or virtually rather than physically, can temporally stand in or serve as a substitute for the processor core in the clearance mode to undertake the adjustment of the operating parameters. The adjustment can be performed on the pseudo processor core until the processor core is changed back to the active mode. Moreover, when the processor core transitions back to the active mode, its operating perameters can be adjusted based on the final operating parameters of the pseudo processor core.

In one embodiment, the removal and migration of workload may occur at a time that is more appropriate for the processor core. For example, the target processor core may continue execution of a currently running task until the execution reaches a defined point before the currently running task is migrated for entering the clearance mode. In an alternative embodiment, the target processor core may delay migration of a currently running task from the target processor core until it is time for the target processor core to receive a next task scheduling event.

Furthermore, at step 302, the multicore processor system 100 is configured to prevent task assignment to the target processor core (e.g., by removing the target processor core from the scheduling configuration 220 of FIG. 2, or by adjusting its measure of appropriateness). At this point, the target processor core has entered the clearance mode. If the target processor core is to enter the power-off state, at step 303, the content in the L1 cache of the target processor core may be flushed to the system memory and the L1 cache may be turned off, and the target processor core may transition into a power-off state. Alternatively, if the target processor core is to enter the ultra-low power state, at step 304, the contents in the L1 cache of the target processor core may be maintained and the target processor core is transitioned into the ultra-low power state.

At step 305, it is determined whether all processor cores in the cluster (in which the target processor core is located) are in the clearance mode; that is, none of the processor core in that cluster is in the active mode. If at least one processor core in the cluster is not in the clearance mode, the process 300 returns to step 301. When all processor cores of the cluster are in the clearance mode and their power states have transitioned into the power-off state or the ultra-low state, the one or more components shared by all of these processor cores may also transition into the power-off state or the ultra-low power state. These shared components may include one or more caches (such as the L2 cache), memory interfaces, etc. Before the shared components enter the power-off state, at step 306, one or more caches in the shared components may be flushed; for example, by writing their contents to the system memory, and the cache coherence between the cluster and one or more other clusters may be disabled. If the shared components are to enter the ultra-low power state, at step 307, the content of the caches in the shared components is maintained, and the cache coherence between the cluster and one or more other clusters is also maintained. Then at step 308, the shared components enter the power-off state or the ultra-low power state. At step 309, the cluster transitions into the power-off or ultra- low power state. The process 300 then returns to step 301 where the system determines whether another processor core in another cluster should enter the clearance mode according to a system policy.

When a processor core enters the clearance mode, system modules including the scheduling module 140 and one or more other system modules are prevented from waking up the processor core to handle work. The system may determine when the processor core may be woken up according to predetermined system policy. For example, when the system receives a task specifically directed to a target processor core in the clearance mode and in the power-off state or the ultra-low power state and where the task cannot be diverted or disabled, the target processor core may be powered on to handle the task. After the task is handled, the target processor core may transition back into the clearance mode and from the power-on state back to the power-off state or the ultra-low power state.

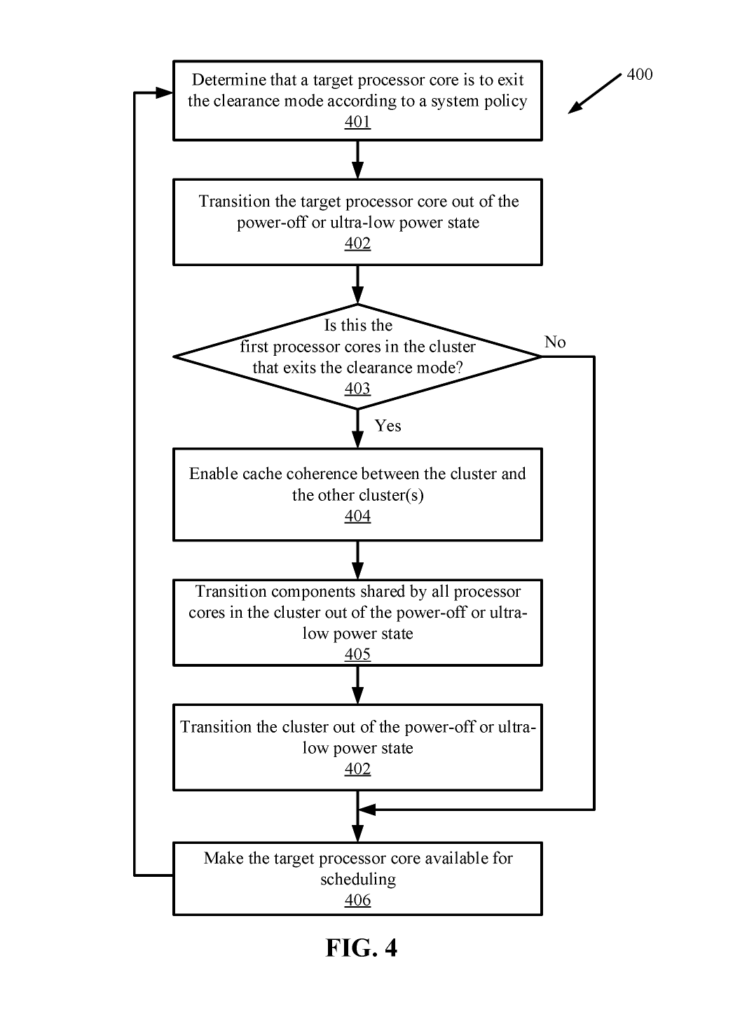

FIG. 4 is a flow diagram illustrating a process 400 of a target processor core exiting the clearance mode according to one embodiment. The process 400 may be performed by a system such as the multicore processor system 100 of FIG. 1. In this embodiment, the system includes a target processor core that is in the clearance mode and in the power-off or ultra-low power state. When the system determines at step 401 that the target processor core is to exit the clearance mode according to a system policy, the target processor core at step 402 transitions out of the power-off or ultra-low power state. It is then determined at step 403 whether the target processor core is the first processor core in its cluster to exit the clearance mode; that is, the target processor core is the first processor core in its cluster to enter the active mode. If the target processor core is the first in the cluster to exit the clearance mode, then the cache coherence between the cluster and the other cluster(s) is enabled at step 404, and the components shared by all processor cores in the cluster also transition out of the power-off or ultra-low power state at step 405. These shared components may include one or more caches (such as the L2 cache), memory interfaces, etc. Then at step 406 the cluster transitions out of the power-off or ultra-low power state. The process 400 then proceeds to step 407. If at step 403 it is determined that the target processor core is not the first in the cluster to exit the clearance mode, the process 400 also proceeds to step 407. At step 407, the target processor core is made available for scheduling such that it can start receiving assigned tasks. For example, the target processor core can be added to the scheduling configuration 220 of the scheduling module 140 (FIG. 2) to enable task assignments to the target processor core. The target processor core may remain idle before it receives scheduled tasks. In one embodiment, the GIC may determine whether to restore the target processor core's function of handling interrupt requests when it exits the clearance mode; such function may be restored to help carrying the system workload of interrupt handling, or may remained disabled for the target processor core. The process 400 may return to step 401 at which the system determines whether another processor core should exit the clearance mode according to a system policy.

In one embodiment, a batch of processor cores may enter the clearance mode in parallel, and/or may exit the clearance mode in parallel. With the processor cores enter/exit the clearance mode in parallel, the scheduling configuration 220 may only need to be updated once to remove the processor cores from scheduling or to make the processor cores available for scheduling. In an alternative embodiment, a batch of processor cores may enter the clearance mode sequentially, and/or may exit the clearance mode sequentially.

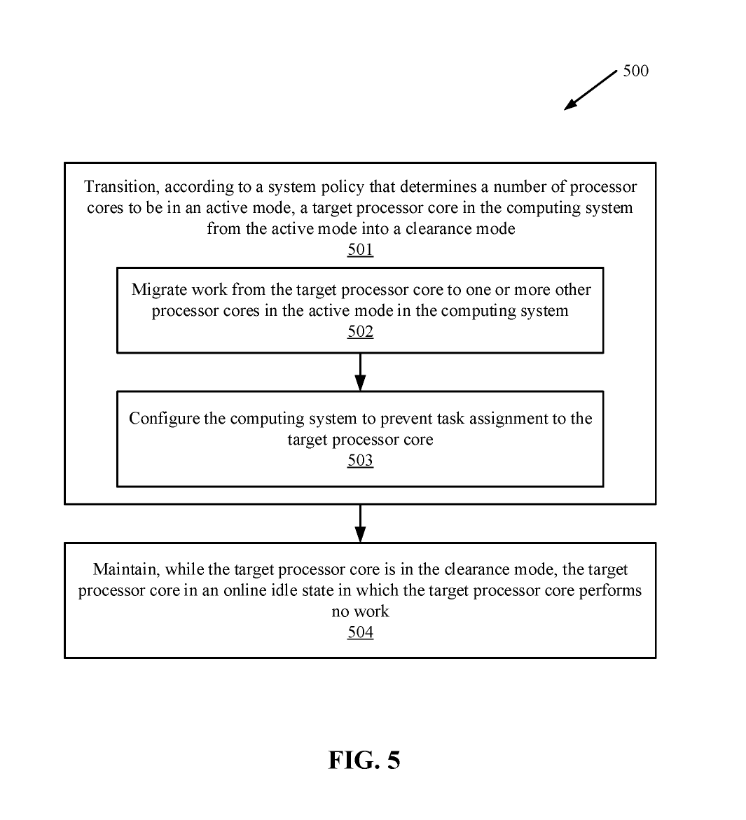

FIG. 5 is a flow diagram illustrating a method 500 for managing mode transitions in a multicore processor system according to one embodiment. The method 500 may be performed by hardware (e.g., circuitry, dedicated logic, programmable logic, microcode, etc.), software (e.g., instructions run on a processing device), firmware, or a combination thereof In one embodiment, the method 500 may be performed by the multicore processor system 100 of FIG. 1.

In one embodiment, the method 500 begins when a computing system transitions a target processor core from an active mode into a clearance mode, according to a system policy that determines the number of processor cores to be in the active mode (step 501). The transition into the clearance mode further includes the steps of: migrating work from the target processor core to one or more other processor cores in the active mode in the computing system (step 502); removing the target processor core from a scheduling configuration of the computing system to prevent task assignment to the target processor core (step 503). When the target processor core is in the clearance mode, the target processor core is maintained in an online idle state in which the target processor core performs no work (step 504).

The operations of the flow diagrams of FIGS. 3-5 have been described with reference to the exemplary embodiments of FIGS. 1-2. However, it should be understood that the operations of the flow diagrams of FIGS. 3-5 can be performed by embodiments of the invention other than those discussed with reference to FIGS. 1-2, and the embodiments discussed with reference to FIGS. 1-2 can perform operations different than those discussed with reference to the flow diagrams. While the flow diagrams of FIGS. 3-5 show a particular order of operations performed by certain embodiments of the invention, it should be understood that such order is exemplary (e.g., alternative embodiments may perform the operations in a different order, combine certain operations, overlap certain operations, etc.).

Various functional components or blocks have been described herein. As will be appreciated by persons skilled in the art, the functional blocks will preferably be implemented through circuits (either dedicated circuits, or general purpose circuits, which operate under the control of one or more processors and coded instructions), which will typically comprise transistors that are configured in such a way as to control the operation of the circuity in accordance with the functions and operations described herein. The specific structure or interconnections of the transistors may be determined by a compiler, such as a register transfer language (RTL) compiler. RTL compilers operate upon scripts that closely resemble assembly language code, to compile the script into a form that is used for the layout or fabrication of the ultimate circuitry. RTL is well known for its role and use in the facilitation of the design process of electronic and digital systems.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for operating a computing system that includes a plurality of processor cores, comprising:
transitioning a target processor core in the computing system from an active mode into a clearance mode according to a system policy that determines a number of processor cores to be in the active mode, wherein the transitioning into the clearance mode comprises:
migrating work from the target processor core to one or more other processor cores in the active mode in the computing system; and
configuring the computing system to prevent task assignment to the target processor core; and
maintaining, while the target processor core is in the clearance mode, the target processor core in an online idle state in which the target processor core performs no work.

2. The method of claim 1, wherein configuring the computing system to prevent task assignment to the target processor core comprises removing the target processor core from a scheduling configuration of the computing system.

3. The method of claim 2, further comprising waking up the target processor core from the clearance mode, wherein waking up the target processor core further comprises:
adding the target processor core to a scheduling configuration to enable the task assignment to the target processor core.

4. The method of claim 1, wherein configuring the computing system to prevent task assignment to the target processor core comprises changing a measure of appropriateness associated with the target processor core such that in determining appropriateness of assigning tasks to the processor cores, assigning the tasks to the target processor core is less appropriate compared to assigning the tasks to the other processor cores in the active mode.

5. The method of claim 4, further comprising waking up the target processor core from the clearance mode, wherein waking up the target processor core further comprises:
recovering the measure of appropriateness associated with the target processor core to enable the task assignment to the target processor core.

6. The method of claim 1, wherein when the target processor core is in the clearance mode, an operating system (OS) kernel of the computing system continues to maintain data structures associated with the target processor core in one or more memory devices.

7. The method of claim 6, wherein when the target processor core is in the clearance mode, the OS kernel of the computing system maintains at least a first portion of data structures of a logical context associated with the target processor core, while freeing a second portion of the data structures of the logical context associated with the target processor core.

8. The method of claim 7, wherein when the target processor core wakes up from the clearance mode, the method further comprises:
allocating and initializing the second portion of the data structures without allocating and initializing the first portion of the data structures.

9. The method of claim 1, wherein when the target processor core is in the clearance mode, an OS kernel of the computing system maintains entire data structures of a logical context associated with the target processor core in one or more memory devices.

10. The method of claim 1, further comprising: transitioning a power state of the target processor core into a power-off state or an ultra-low power state.

11. The method of claim 10, wherein transitioning the power state further comprises:
causing one or more components shared by all processor cores of a target cluster in which the target processor core is located to enter the power-off state or the ultra-low power state when all of the processor cores in the target cluster are in the clearance mode and in the power-off state or the ultra-low power state.

12. The method of claim 11, further comprising:
flushing one or more shared caches in the one or more components and disabling cache coherence between the target cluster and one or more other clusters in the computing system before the one or more components enter the power-off state.

13. The method of claim 11, further comprising:
maintaining contents of one or more shared caches in the one or more components and maintaining cache coherence between the target cluster and one or more other clusters in the computing system before the one or more components enter the ultra-low power state.

14. The method of claim 11, further comprising waking up the target processor core from the clearance mode, wherein waking up the target processor core further comprises:
transitioning the one or more shared components out of the power-off state or the ultra-low power state.

15. The method of claim 10, further comprising waking up the target processor core from the clearance mode, wherein waking up the target processor core further comprises:
transitioning the target processor core out of the power-off state or the ultra-low power state.

16. The method of claim 10, further comprising:
receiving an interrupt directed to the target processor core in the clearance mode and in the power-off state or the ultra-low power state;
powering on the target processor core to handle the interrupt; and
transitioning the target processor core from a power-on state back to the power-off state or the ultra-low power state after the interrupt is handled.

17. The method of claim 1, further comprising:
preventing one or more system modules from waking up the target processor core in the clearance mode to handle work.

18. The method of claim 1, wherein migrating the work further comprises:
migrating a function of handling future external events from the target processor core to at least one of the one or more processor cores in the active mode; and
migrating existing workload from the target processor core to at least one of the one or more processor cores in the active mode.

19. The method of claim 1, wherein transitioning into the clearance mode further comprises:
continuing, by the target processor core, execution of a currently running task until the execution reaches a defined point before migrating the currently running task for entering the clearance mode.

20. The method of claim 1, wherein transitioning into the clearance mode further comprises:
delaying migration of a currently running task from the target processor core until it is time for the target processor core to receive a next task scheduling event.

21. The method of claim 1, further comprising: preventing adjustments to operating parameters of the target processor core in the clearance mode.

22. The method of claim 1, further comprising:
adjusting operating parameters of a pseudo processor core standing in for the target processor core when the operating parameters of the target processor core in the clearance mode are required to be adjusted; and
utilizing the adjusted operating parameters of the pseudo processor core to adjust the target processor core when the target processor core switches back to the active mode.

23. A computing system comprising a plurality of processor cores and memory, the memory containing instructions executable by the plurality of processor cores, wherein the computing system is operative to:
transition a target processor core in the computing system from an active mode into a clearance mode according to a system policy that determines a number of processor cores to be in the active mode, wherein the transitioning into the clearance mode comprises:
migrate work from the target processor core to one or more other processor cores in the active mode in the computing system; and
configure the computing system to prevent task assignment to the target processor core; and
maintain, while the target processor core is in the clearance mode, the target processor core in an online idle state in which the target processor core performs no work.

24. The computing system of claim 23, wherein, when configuring the computing system to prevent task assignment to the target processor core, the computing system is further operative to remove the target processor core from a scheduling configuration of the computing system.

25. The computing system of claim 24, wherein the computing system is further operative to wake up the target processor core from the clearance mode, and add the target processor core to a scheduling configuration to enable the task assignment to the target processor core.

26. The computing system of claim 23, wherein, when configuring the computing system to prevent task assignment to the target processor core, the computing system is further operative to change a measure of appropriateness associated with the target processor core such that in determining appropriateness of assigning tasks to the processor cores, assigning the tasks to the target processor core is less appropriate compared to assigning the tasks to the other processor cores in the active mode.

27. The computing system of claim 26, wherein the computing system is further operative to wake up the target processor core from the clearance mode, and recover the measure of appropriateness associated with the target processor core to enable the task assignment to the target processor core.

28. The computing system of claim 23, wherein when the target processor core is in the clearance mode, an operating system (OS) kernel of the computing system continues to maintain data structures associated with the target processor core in one or more memory devices.

29. The computing system of claim 28, wherein when the target processor core is in the clearance mode, the OS kernel of the computing system maintains at least a first portion of data structures of a logical context associated with the target processor core, while freeing a second portion of the data structures of the logical context associated with the target processor core.

30. The computing system of claim 29, wherein when the target processor core wakes up from the clearance mode, the computing system is further operative to allocate and initialize the second portion of the data structures without allocating and initializing the first portion of the data structures.

31. The computing system of claim 23, wherein when the target processor core is in the clearance mode, an OS kernel of the computing system maintains entire data structures of a logical context associated with the target processor core in one or more memory devices.

32. The computing system of claim 23, wherein the computing system is further operative to transition a power state of the target processor core into a power-off state or an ultra-low power state.

33. The computing system of claim 32, wherein, when transitioning the power state, the computing system is further operative to cause one or more components shared by all processor cores of a target cluster in which the target processor core is located to enter the power-off state or the ultra-low power state when all of the processor cores in the target cluster are in the clearance mode and in the power-off state or the ultra-low power state.

34. The computing system of claim 33, wherein the computing system is further operative to flush one or more shared caches in the one or more components and disabling cache coherence between the target cluster and one or more other clusters in the computing system before the one or more components enter the power-off state.

35. The computing system of claim 33, wherein the computing system is further operative to maintain contents of one or more shared caches in the one or more components and maintaining cache coherence between the target cluster and one or more other clusters in the computing system before the one or more components enter the ultra-low power state.

36. The computing system of claim 33, wherein the computing system is further operative to wake up the target processor core from the clearance mode and transition the one or more shared components out of the power-off state or the ultra-low power state.

37. The computing system of claim 32, wherein the computing system is further operative to wake up the target processor core from the clearance mode and transition the target processor core out of the power-off state or the ultra-low power state.

38. The computing system of claim 32, wherein the computing system is further operative to:
receive an interrupt directed to the target processor core in the clearance mode and in the power-off state or the ultra-low power state;
power on the target processor core to handle the interrupt; and
transition the target processor core from a power-on state back to the power-off state or the ultra-low power state after the interrupt is handled.

39. The computing system of claim 23, wherein the computing system is further operative to prevent one or more system modules from waking up the target processor core in the clearance mode to handle work.

40. The computing system of claim 23, wherein, when migrating the work, the computing system is further operative to:
migrate a function of handling future external events from the target processor core to at least one of the one or more processor cores in the active mode; and
migrate existing workload from the target processor core to at least one of the one or more processor cores in the active mode.

41. The computing system of claim 23, wherein, when transitioning into the clearance mode, the computing system is further operative to:
continue, by the target processor core, execution of a currently running task until the execution reaches a defined point before migrating the currently running task for entering the clearance mode.

42. The computing system of claim 23, wherein, when transitioning into the clearance mode, the computing system is further operative to:
delay migration of a currently running task from the target processor core until it is time for the target processor core to receive a next task scheduling event.

43. The computing system of claim 23, wherein the computing system is further operative to prevent adjustments to operating parameters of the target processor core in the clearance mode.

44. The computing system of claim 23, wherein the computing system is further operative to:
adjust operating parameters of a pseudo processor core standing in for the target processor core when the operating parameters of the target processor core in the clearance mode are required to be adjusted; and
utilize the adjusted operating parameters of the pseudo processor core to adjust the target processor core when the target processor core switches back to the active mode.
